(19) United States
(12) Patent Application Publication
(10) Pub. No.: US 2010/0319188 A1
(43) Pub. Date: Dec. 23, 2010

(54) MANUFACTURING METHOD OF POWER STORAGE DEVICE

(75) Inventors: Shunpei Yamazaki, Tokyo (JP); Yasuyuki Arai, Atsugi (JP); Miho Komori, Isehara (JP); Yukie Suzuki, Atsugi (JP); Tatsuya Takahashi, Atsugi (JP)

Correspondence Address: FISH & RICHARDSON P.C. (DC), P.O. BOX 1022, MINNEAPOLIS, MN, 55440-1022, US

(73) Assignee: SEMICONDUCTOR ENERGY LABORATORY CO., LTD., Atsugi-shi (JP)

(21) Appl. No.: 12/793,313

(22) Filed: Jun. 3, 2010

(30) Foreign Application Priority Data
Jun. 19, 2009 (JP) 2009-146227

(51) Int. Cl. H01M 10/04; H01M 2/00

(52) U.S. Cl. 29/623.5

(57) ABSTRACT

A safe method of manufacturing an electrode of a power storage device even when an alkali metal is used in forming the electrode. A negative electrode is manufactured by forming an alkali metal ion insertion/extraction layer which is a layer capable of alkali metal ion insertion and extraction on a surface of a current collector, forming an alkali metal film under reduced pressure on a surface of the alkali metal ion insertion/extraction layer, ionizing the alkali metal film, and impregnating the alkali metal ion insertion/extraction layer with the ionized alkali metal.

### BACKGROUND OF THE INVENTION

1. Field of the Invention

An embodiment of the present invention relates to a power storage device.

2. Description of the Related Art

In recent years, the development of power storage devices such as a lithium-ion secondary battery (also referred to as a rechargeable battery) and a lithium-ion capacitor has been conducted.

By forming an active material on a surface of a current collector, an electrode of a power storage device, such as the above-mentioned lithium-ion secondary battery or lithium-ion capacitor, can be manufactured. Furthermore, to obtain high operating voltage, technology for inserting an alkali metal ion, such as lithium or sodium, into an active material in advance (also referred to as pre-doping technology) is known (see Patent Document 1, for example).

For the manufacture of negative electrodes, Patent Document 1 discloses forming a layer that includes a material capable of lithium-ion insertion and extraction formed on a surface of a current collector, and pressing and bonding a separately prepared lithium foil onto a surface of the layer that includes the material capable of lithium-ion insertion and extraction so as to introduce lithium ions into the layer that includes the material capable of lithium-ion insertion and extraction. Lithium and other alkali metals are highly reactive in general; for example, they react intensely with water. For this reason, alkali metals are dangerous and management of them is difficult.

### REFERENCE

[Patent Document 1] Japanese Published Patent Application No. H8-107048

### SUMMARY OF THE INVENTION

It is an object of an embodiment of the present invention to safely manufacture an electrode of a power storage device even when an alkali metal is used in forming the electrode.

In an embodiment of the present invention regarding the manufacture of a power storage device, an alkali metal film is deposited under reduced pressure on a surface of a layer capable of alkali metal ion insertion and extraction, and using the deposited alkali metal film, an active material of an electrode impregnated with an alkali metal ion is manufactured.

An embodiment of the present invention is a method for manufacturing a power storage device having a positive electrode, a negative electrode, and an electrolyte, and the manufacturing method of the power storage device is characterized in that the negative electrode is manufactured by forming a layer capable of alkali metal ion insertion and extraction on a surface of a current collector of the negative electrode, forming an alkali metal film under reduced pressure on the layer capable of alkali metal ion insertion and extraction, ionizing the aforementioned alkali metal film and impregnating the layer capable of alkali metal ion insertion and extraction with an alkali metal ion.

Note that in an embodiment of the present invention, the alkali metal film may be formed by using a chemical vapor deposition method.

Alternatively, in an embodiment of the present invention, the alkali metal film may be formed by using a physical vapor deposition method.

Furthermore, in an embodiment of the present invention, the physical vapor deposition method may be a vacuum evaporation method or a sputtering method.

According to an embodiment of the present invention, since the danger in using alkali metal can be reduced, an electrode and a power storage device having the electrode can be manufactured more safely.

### BRIEF DESCRIPTION OF THE DRAWINGS

FIGS. 1A and 1B are diagrams showing structures of power storage devices.

FIGS. 2A to 2C are cross-sectional views of an example of a manufacturing method of a power storage device.

FIG. 3 is a schematic diagram of a chemical vapor deposition apparatus.

### DETAILED DESCRIPTION OF THE INVENTION

Hereinafter, examples of embodiments of the present invention will be described with reference to the drawings. Note that the invention is not limited to the following description, and it will be easily understood by those skilled in the art that various changes and modifications can be made without departing from the spirit and scope of the invention. Thus, the present invention should not be interpreted as being limited to the following description of the embodiments. In description with reference to the drawings, in some cases, the same reference numerals are used in common for the same portions in different drawings. Further, in some cases, the same hatching patterns are applied to similar parts, and the similar parts are not necessarily designated by reference numerals.

### Embodiment 1

This embodiment will describe a power storage device.

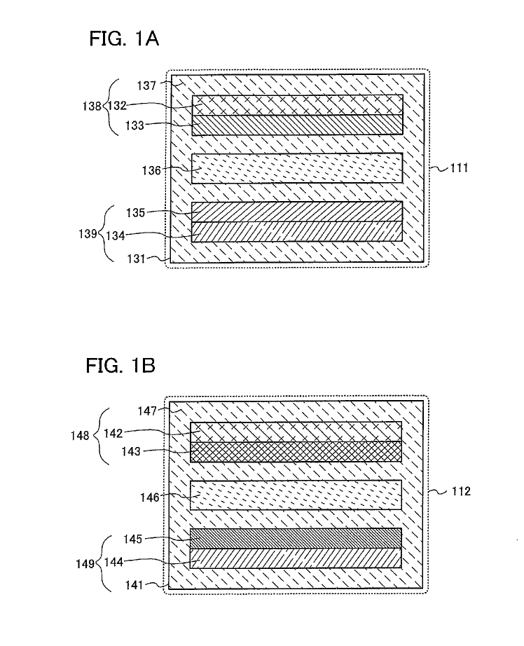

As the power storage device, a capacitor and a secondary battery (also called a rechargeable battery) are included. A structure of a capacitor 111 is shown in FIG. 1A and a structure of a secondary battery 112 is shown in FIG. 1B.

The capacitor 111 has a housing 131, a positive electrode 138 including a positive electrode current collector 132 and a positive electrode active material 133, a negative electrode 139 including a negative electrode current collector 134 and a negative electrode active material 135, a separator 136 placed between the positive electrode 138 and the negative electrode 139, and an electrolyte 137.

As the positive electrode current collector 132, an element such as aluminum (Al) or titanium (Ti), or a compound thereof may be used.

As the positive electrode active material 133, a material such as activated carbon, carbon nanotube, fullerene, or polyacene may be used.

As the negative electrode current collector 134, an element such as copper (Cu), aluminum (Al), nickel (Ni), or titanium (Ti), or a compound thereof may be used.

The negative electrode active material 135 includes a material capable of alkali metal ion insertion and extraction and an alkali metal compound. The material capable of alkali metal ion insertion and extraction is a material such as carbon, silicon, and a silicon alloy. As the carbon capable of alkali metal ion insertion and extraction, it is possible to use a carbon material such as a fine graphite powder or a graphite fiber.

Additionally, when a silicon material is used as the negative electrode active material 135, a material obtained by depositing microcrystalline silicon and then removing amorphous silicon from the microcrystalline silicon by etching may be used. When amorphous silicon is removed from the microcrystalline silicon, the surface area of the remaining microcrystalline silicon is increased.

In a layer formed by a material capable of alkali metal ion insertion and extraction, a reaction caused by the insertion of an alkali metal such as lithium, sodium, and potassium forms the negative electrode active material 135.

As the separator 136, paper, nonwoven fabric, glass fiber, or synthetic fiber may be used. As the synthetic fiber, such materials as nylon (polyamide), vinylon (also called vinalon) (polyvinyl alcohol fiber), polyester, acrylic, polyolefin, and polyurethane may be used. However, it is necessary to choose a material which will not dissolve in the electrolyte 137, which will be described later, as the separator 136.

More specific examples of materials of the separator 136 are polymer materials (high-molecular compounds) such as fluorine-based polymer, polyether (e.g., polyethylene oxide and polypropylene oxide), polyolefin (e.g., polyethylene and polypropylene), polyacrylonitrile, polyvinylidene chloride, polymethyl methacrylate, polymethylacrylate, polyvinyl alcohol, polymethacrylonitrile, polyvinyl acetate, polyvinylpyrrolidone, polyethyleneimine, polybutadiene, polystyrene, polyisoprene, polyurethane, derivatives thereof, cellulose, paper, and nonwoven fabric. These materials can be used either alone or in combination as the separator 136.

The electrolyte 137 includes an alkali metal ion which is responsible for electrical conduction. The electrolyte 137 includes, for example, a solvent and an alkali metal salt dissolved in the solvent. Examples of the alkali metal salt for use in the electrolyte 137 include a sodium salt such as sodium chloride (NaCl), sodium fluoride (NaF), sodium perchlorate (NaClO₄), sodium fluoroborate (NaBF₄), lithium chloride (LiCl), lithium fluoride (LiF), lithium perchlorate (LiClO₄), lithium fluoroborate (LiBF₄), potassium chloride (KCl), potassium fluoride (KF), potassium perchlorate (KClO₄), and potassium fluoroborate (KBF₄). These materials can be used either alone or in combination in the electrolyte 137.

Examples of the solvent of the electrolyte 137 include a cyclic carbonate such as ethylene carbonate (EC), propylene carbonate (PC), butylene carbonate (BC), and vinylene carbonate (VC); an acyclic carbonate such as dimethyl carbonate (DMC), diethyl carbonate (DEC), ethylmethyl carbonate (EMC), methylpropyl carbonate (MPC), methylisobutyl carbonate (MIPC), and dipropyl carbonate (DPC); an aliphatic carboxylic acid ester such as methyl formate, methyl acetate, methyl propionate, and ethyl propionate; a γ-lactone such as γ-butyrolactone; an acyclic ether such as 1,2-dimethoxyethane (DME), 1,2-diethoxyethane (DEE), and ethoxymethoxy ethane (EME); a cyclic ether such as tetrahydrofuran and 2-methyltetrahydrofuran; an alkyl phosphate ester such as dimethylsulfoxide, 1,3-dioxolane, trimethyl phosphate, triethyl phosphate, and trioctyl phosphate; and fluorides thereof. These materials can be used either alone or in combination as the solvent of the electrolyte 137.

The secondary battery 112 has a housing 141, a positive electrode 148 including a positive electrode current collector 142 and a positive electrode active material 143, a negative electrode 149 including a negative electrode current collector 144 and a negative electrode active material 145, a separator 146 placed between the positive electrode 148 and the negative electrode 149, and an electrolyte 147.

The similar material as that of the positive electrode current collector 132 which is included in the capacitor 111 may be used for the positive electrode current collector 142 which is included in the secondary battery 112.

An alkali metal containing composite oxide may be used as the positive electrode active material 143. Materials that may be used as the alkali metal containing composite oxide are an oxide including an alkali metal such as sodium, lithium, and potassium and a transition metal such as cobalt, nickel, manganese, and iron. Some examples which may be given for an oxide including lithium and a transition metal are LiCoO₂, LiNiO₂, LiMnO₂, and LiFePO₄. Additionally, the alkali metal containing composite oxide may include plural kinds of transition metals.

The similar material as that of the negative electrode current collector 134 which is included in the capacitor 111 may be used as the negative electrode current collector 144 which is included in the secondary battery 112.

The similar material as that of the negative electrode active material 135 which is included in the capacitor 111 may be used as the negative electrode active material 145 which is included in the secondary battery 112.

Additionally, an alloy including tin (Sn) may be used as the negative electrode active material 145 of the secondary battery 112.

The similar materials as those of the separator 136 and the electrolyte 137 which are included in the capacitor 111 may be used as the separator 146 and the electrolyte 147 which are included in the secondary battery 112.

Next, a manufacturing method of a power storage device will be described.

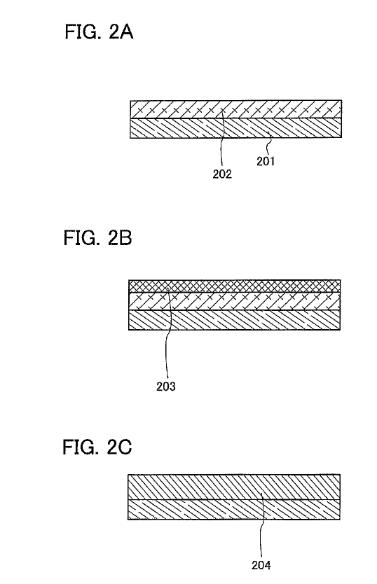

Using FIGS. 2A to 2C, a manufacturing method of a power storage device of the present embodiment will be described. FIGS. 2A to 2C are cross-sectional diagrams which show an example of the manufacturing method of the power storage device.

First, as shown in FIG. 2A, a current collector 201 is prepared and a layer capable of alkali metal ion insertion and extraction (herein, also referred to as alkali metal ion insertion/extraction layer 202) is formed on a surface of the current collector 201.

For example, the applicable materials of the negative electrode current collector 134 shown in FIG. 1A may be used for the current collector 201.

It is possible to form the alkali metal ion insertion/extraction layer 202 using a material capable of alkali metal ion insertion and extraction. For example, by combining a binder and a conductive material with a material capable of alkali metal ion insertion and extraction, and spreading the obtained mixture into a sheet form and drying the sheet, the alkali metal ion insertion/extraction layer 202 can be formed. As the material capable of alkali metal ion insertion and extraction, for example, the applicable materials of the negative electrode active material 135 shown in FIG. 1A, such as a carbon material, a silicon material, or a silicon alloy material, may be used. Also, when not a lithium ion but a sodium ion is used as the alkali metal ion for example, the manufacturing cost of the power storage device can be reduced. Furthermore, a material such as a resin material for example, may be used as the binder. Additionally, such materials as carbon black or acetylene black for example, can be used as the conductive material.

Next, as shown in FIG. 2B, an alkali metal film 203 is formed on a surface of the alkali metal ion insertion/extraction layer 202.

In the formation of the negative electrode active material 135, the alkali metal film 203 is formed on the surface of the alkali metal ion insertion/extraction layer 202 in an atmosphere with the moisture and oxygen removed, typically under reduced pressure. Typical examples of manufacturing methods for the alkali metal film 203 are such methods as physical vapor deposition (also called a PVD) and chemical vapor deposition (also called a CVD).

As the physical vapor deposition method, for example, a vacuum evaporation method or sputtering method can be used. In the sputtering method, for example, the alkali metal film 203 is formed by sputtering a target of chloride or fluoride of an alkali metal using a noble gas ion, and reducing the chloride or fluoride of an alkali metal with hydrogen.

As the chemical vapor deposition method, for example, a method such as plasma CVD, thermal CVD, and MOCVD (metal organic chemical vapor deposition) can be used. By forming the alkali metal film 203 with these deposition methods, and since the alkali metal film 203 can be formed without exposure to air, a negative electrode active material and negative electrode can be safely formed. Note that in FIG. 2B, the alkali metal film 203 having a uniform thickness is shown, but is not limited thereto, and may have a region with differing film thicknesses or may be a plurality of divided regions.

After that, while ionzining the alkali metal film 203, the alkali metal ion insertion/extraction layer 202 is impregnated with an ionized alkali metal. As shown in FIG. 2C, an active material 204 is formed and a negative electrode can be manufactured by sequential progression of ionization of the alkali metal film 203, and by impregnating the alkali metal ion insertion/extraction layer 202 with the alkali metal ion from the alkali metal film 203. At this time, as shown in FIG. 2C, the active material 204 may expand further than the alkali metal ion insertion/extraction layer 202. However, not being limited thereto, the expansion of the active material 204 can be suppressed by using a material that does not expand.

As an example shown in FIGS. 2A to 2C, there is a method of manufacturing a power storage device of this embodiment in which after forming the alkali metal film under reduced pressure on a surface of the layer capable of alkali metal ion insertion and extraction, the layer capable of alkali metal ion insertion and extraction is impregnated with an alkali metal ion from the alkali metal film. Accordingly, since the danger in using an alkali metal can be reduced, an electrode can be more safely manufactured.

Note that this embodiment can be combined or substituted with any of the other embodiments as appropriate.

### Embodiment 2

Next, as one mode of a method for forming an alkali metal film on a surface of a layer capable of alkali metal ion insertion and extraction, a mode which uses a CVD method is shown.

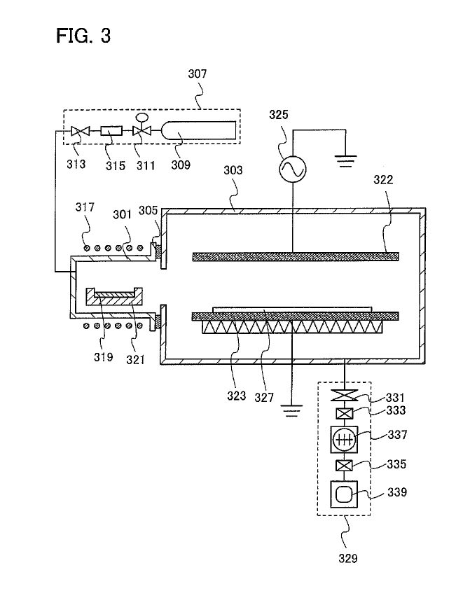

FIG. 3 shows a schematic diagram of a chemical vapor deposition apparatus. The chemical vapor deposition apparatus includes a first reaction chamber 301 for gasification of a source material which is connected by an O-ring 305, and the like, to a second reaction chamber 303 for forming an alkali metal film by CVD using the gas produced in the first reaction chamber 301 as the source material on a surface of a layer capable of alkali metal ion insertion and extraction. Note that the first reaction chamber 301 and the second reaction chamber 303 are open to each other, and the gas produced in the first reaction chamber 301 can be introduced into the second reaction chamber 303.

The first reaction chamber 301 is formed of quartz. Additionally, the first reaction chamber 301 is connected to a gas supply unit 307 by a gas line. The gas supply unit 307 includes a cylinder 309 which is filled with a gas, a pressure adjusting valve 311, a stop valve 313, a mass flow controller 315, and the like. Here, a reducing gas, typically hydrogen, is included in the cylinder 309 of the gas supply unit 307. Note that, as the cylinder 309 including the reducing gas, a cylinder including a noble gas such as helium, neon, and argon may be provided instead. A high frequency (also referred to as a radio frequency) coil 317 is provided in a periphery of the first reaction chamber 301. Also, a silicon susceptor 321 can be provided within the first reaction chamber 301. An alkali metal compound 319 is held by the silicon susceptor 321. As the alkali metal compound 319, a halide (e.g., potassium fluoride, sodium fluoride, calcium fluoride, potassium chloride, sodium chloride, calcium chloride, and the like), an oxide (e.g., lithium oxide, sodium oxide, potassium oxide, and the like), a nitrate (e.g., lithium nitrate, sodium nitrate, potassium nitrate, and the like), a phosphate (e.g., lithium phosphate, sodium phosphate, potassium phosphate, and the like), a carbonate (e.g., lithium carbonate, sodium carbonate, potassium carbonate, and the like), an organometallic compound (an organometallic compound including lithium, sodium, and/or potassium), and other compounds which include an alkali metal, may be suitably used.

Here, the second reaction chamber 303 is formed with a material having rigidity, such as aluminum or stainless steel, and is structured so that the inside can be vacuum evacuated. In the second reaction chamber 303, a first electrode 322 (also called an upper electrode) and a second electrode 323 (also called a lower electrode) are provided.

A high frequency power supply unit 325 is connected to the first electrode 322. The high frequency power supply unit 325 includes a high frequency power source, a matching box, a high frequency cut filter, and the like. A high frequency power output from the high frequency power supply unit 325 is supplied to the first electrode 322. Additionally, the second electrode 323 is grounded, and a substrate 327 can be mounted thereover, Note that an insulation material is provided between the first electrode 322 and the second reaction chamber 303 and between the second electrode 323 and the second reaction chamber 303, so that a high frequency power does not leak from the second reaction chamber 303.

Also, FIG. 3 shows a capacitively coupled type structure (a parallel plate type structure) having the first electrode 322 and the second electrode 323, but is not limited thereby. As long as high frequency power is supplied and glow discharge plasma can be produced in the second reaction chamber 303, another structure such as an inductively coupled type structure can be employed. Furthermore, without being limited to a chemical vapor deposition apparatus capable of plasma CVD, a chemical vapor deposition apparatus capable of thermal CVD, MOCVD, and the like can be suitably employed.

The second reaction chamber 303 is connected to an exhaust unit 329 for a vacuum exhaust in the first reaction chamber 301 or the second reaction chamber 303, and for adjusting pressure. A structure of the exhaust unit 329 includes as a butterfly valve 331, valves 333 and 335, a turbomolecular pump 337, a dry pump 339, and the like. Note that the exhaust unit 329 can be used in combination with a suitable vacuum pump in accordance with the set pressure of the first reaction chamber 301 and the second reaction chamber 303. Further, by reducing the pressure of the first reaction chamber 301 with the exhaust unit 329, an evaporation temperature of the alkali metal compound 319 held by the silicon susceptor 321 can be lowered.

For example, when a saturated vapor pressure is 1 Torr (133 Pa), the temperature of lithium fluoride becomes 1047° C., lithium chloride becomes 783° C., sodium fluoride becomes 1077° C., and sodium chloride becomes 865° C. For this reason, by lowering a pressure of the first reaction chamber 301 below 1 Torr, a sublimation temperature and an evaporation temperature of each alkali metal compound can be reduced.

Next, a method for forming an alkali metal film on a surface of a layer capable of alkali metal ion insertion and extraction using the CVD apparatus shown in FIG. 3 will be described.

An electrode with a layer capable of alkali metal ion insertion and extraction is mounted over the second electrode 323 of the second reaction chamber 303. Then, by opening the pressure adjusting valve 311 and the stop valve 313 of the gas supply unit 307, a hydrogen gas whose flow rate is adjusted by the mass flow controller 315 is introduced from the cylinder 309 to the first reaction chamber 301. Next, the pressure of the first reaction chamber 301 and the second reaction chamber 303 is adjusted by the exhaust unit 329.

Then, a high frequency power is supplied to the high frequency coil 317, and by a high frequency induction of the high frequency coil 317, the silicon susceptor 321 is heated. In this case, the alkali metal compound provided in the silicon susceptor 321 is heated, and the alkali metal compound is gasified.

Since there is the exhaust unit 329 provided in the second reaction chamber 303, the alkali metal compound gas evaporated in the first reaction chamber 301 is moved to the second reaction chamber 303.

Then, a high frequency power is supplied to the first electrode 322 provided in the second reaction chamber 303, thereby causing a glow discharge between the first electrode 322 and the second electrode 323, which generates plasma. In this case, since hydrogen gas in the second reaction chamber 303 is being introduced, the alkali metal ion included in the alkali metal compound gas is reduced in plasma, and an alkal±metal film can be deposited under reduced pressure on a surface of the layer capable of alkali metal ion insertion and extraction.

After this, by impregnating the layer capable of inserting and extracting alkali metal ion with an alkali metal ion from the alkali metal film, an active material can be formed on a surface of a current collector. In this embodiment, since the danger of forming an electrode by using an alkali metal can be reduced, an electrode and a power storage device having the electrode can be manufactured more safely.

This application is based on Japanese Patent Application serial no. 2009-146227 filed with Japan Patent Office on Jun. 19, 2009, the entire contents of which are hereby incorporated by reference.

What is claimed is:

1. A method of manufacturing a power storage device, comprising the steps of:
providing a current collector;
forming a layer capable of inserting and extracting alkali metal ion on a surface of the current collector;
forming an alkali metal film on a surface of the layer capable of inserting and extracting alkali metal ion under reduced pressure; and
impregnating the layer capable of inserting and extracting alkali metal ion with an alkali metal ion while ionizing the alkali metal film.

2. The method of manufacturing the power storage device according to claim 1, wherein the alkali metal film is formed using a chemical vapor deposition method.

3. The method of manufacturing the power storage device according to claim 1, wherein the alkali metal film is formed using a physical vapor deposition method.

4. The method of manufacturing the power storage device according to claim 3, wherein the physical vapor deposition method is a vacuum evaporation method or a sputtering method.

5. The method of manufacturing the power storage device according to claim 1, wherein the alkali metal film is formed of a sodium film.

6. The method of manufacturing the power storage device according to claim 1, wherein the alkali metal film is formed of a potassium film.

7. The method of manufacturing the power storage device according to claim 1,
wherein the power storage device comprises a positive electrode, a negative electrode, and an electrolyte, and
wherein the negative electrode includes the current collector and the layer capable of inserting and extracting alkali metal ion.

8. A method of manufacturing a power storage device, comprising the steps of:
providing a current collector;
forming a mixture by combining a binder and a conductive material with a material capable of inserting and extracting alkali metal ion;
forming a layer capable of inserting and extracting alkali metal ion on a surface of the current collector by using the mixture;
forming an alkali metal film on a surface of the layer capable of inserting and extracting alkali metal ion under reduced pressure; and
impregnating the layer capable of inserting and extracting alkali metal ion with an alkali metal ion while ionizing the alkali metal film.

9. The method of manufacturing the power storage device according to claim 8, wherein the alkali metal film is formed using a chemical vapor deposition method.

10. The method of manufacturing the power storage device according to claim 8, wherein the alkali metal film is formed using a physical vapor deposition method.

11. The method of manufacturing the power storage device according to claim 10, wherein the physical vapor deposition method is a vacuum evaporation method or a sputtering method.

12. The method of manufacturing the power storage device according to claim 8, wherein the alkali metal film is formed of a sodium film.

13. The method of manufacturing the power storage device according to claim 8, wherein the alkali metal film includes a potassium.

14. The method of manufacturing the power storage device according to claim 8,
wherein the power storage device comprises a positive electrode, a negative electrode, and an electrolyte, and
wherein the negative electrode includes the current collector and the layer capable of alkali metal ion insertion and extraction.

15. A method of manufacturing a power storage device, comprising the steps of:
providing a current collector;
forming a layer capable of inserting and extracting alkali metal ion on a surface of the current collector; and
forming an alkali metal film on a surface of the layer capable of inserting and extracting alkali metal ion under reduced pressure.

16. The method of manufacturing the power storage device according to claim 15, wherein the alkali metal film is formed using a chemical vapor deposition method.

17. The method of manufacturing the power storage device according to claim 15, wherein the alkali metal film is formed using a physical vapor deposition method.

18. The method of manufacturing the power storage device according to claim 17, wherein the physical vapor deposition method is a vacuum evaporation method or a sputtering method.

19. The method of manufacturing the power storage device according to claim 15, wherein the alkali metal film is formed of a sodium film.

20. The method of manufacturing the power storage device according to claim 15, wherein the alkali metal film is formed of a potassium film.

21. The method of manufacturing the power storage device according to claim 15,
wherein the power storage device comprises a positive electrode, a negative electrode, and an electrolyte, and
wherein the negative electrode includes the current collector and the layer capable of inserting and extracting alkali metal ion.
